(19) United States
(12) Patent Application Publication
(10) Pub. No.: US 2025/0158935 A1
(43) Pub. Date: May 15, 2025

(54) COMMUNICATION DEVICE AND COMMUNICATION METHOD

(71) Applicant: Realtek Semiconductor Corp., HsinChu (TW)

(72) Inventors: Jia-You Wu, HsinChu (TW); Chiao-Ling Yang, HsinChu (TW)

(73) Assignee: Realtek Semiconductor Corp., HsinChu (TW)

(21) Appl. No.: 18/902,960

(22) Filed: Oct. 1, 2024

(30) Foreign Application Priority Data
Nov. 14, 2023 (TW) 112143885

(51) Int. Cl. H04L 47/32; H04L 5/00

(52) U.S. Cl. CPC H04L 47/323; H04L 5/0007

(57) ABSTRACT

A communication device includes: a transmitting circuit, for transmitting a plurality of association request messages to a plurality of network devices, respectively, wherein each of the plurality of association request messages comprises a same broadcast (BC) address and a same acknowledgement (ACK) policy and the plurality of association request messages comprise a plurality of first ACK priorities, respectively; and a receiving circuit, for receiving a plurality of association response messages corresponding to the plurality of association request messages from the plurality of network devices, respectively.

### BACKGROUND OF THE INVENTION

### 1. Field of the Invention

The present invention relates to a communication device and a communication method used in a wireless communication system, and more particularly, to a communication device and a communication method for reducing an overhead caused by handshakes.

### 2. Description of the Prior Art

In a wireless communication system, a communication device and a network device perform a handshake in order to coordinate an operating mode status. When the communication device is connected to multiple network devices on a same channel, the communication device needs to perform handshakes with the network devices independently according to a communication standard (e.g., IEEE 802.11). This causes overhead to the communication device and an inability to effectively utilize channel resources. Thus, how to reduce the overhead caused by the handshakes is an important problem to be solved.

### SUMMARY OF THE INVENTION

The present invention therefore provides a communication device and a communication method to solve the abovementioned problem.

A communication device comprises: a transmitting circuit, for transmitting a plurality of association request messages to a plurality of network devices, respectively, wherein each of the plurality of association request messages comprises a same broadcast (BC) address and a same acknowledgement (ACK) policy and the plurality of association request messages comprise a plurality of first ACK priorities, respectively; and a receiving circuit, for receiving a plurality of association response messages corresponding to the plurality of association request messages from the plurality of network devices, respectively.

A communication method comprises: transmitting a plurality of association request messages to a plurality of network devices, respectively, wherein each of the plurality of association request messages comprises a same broadcast (BC) address and a same acknowledgement (ACK) policy and the plurality of association request messages comprise a plurality of first ACK priorities, respectively; and receiving a plurality of association response messages corresponding to the plurality of association request messages from the plurality of network devices, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a communication system according to an example of the present invention.

FIG. 2 is a schematic diagram of a communication device according to an example of the present invention.

FIG. 3 is a schematic diagram of a scenario according to an example of the present invention.

FIG. 4 is a schematic diagram of a frame according to an example of the present invention.

FIG. 5 is a schematic diagram of a handshake mechanism according to an example of the present invention.

FIG. 6 is a schematic diagram of a handshake mechanism according to an example of the present invention.

FIG. 7 is a schematic diagram of a handshake mechanism according to an example of the present invention.

FIG. 8 is a schematic diagram of a handshake mechanism according to an example of the present invention.

FIG. 9 is a flowchart of a process according to an example of the present invention.

### DETAILED DESCRIPTION

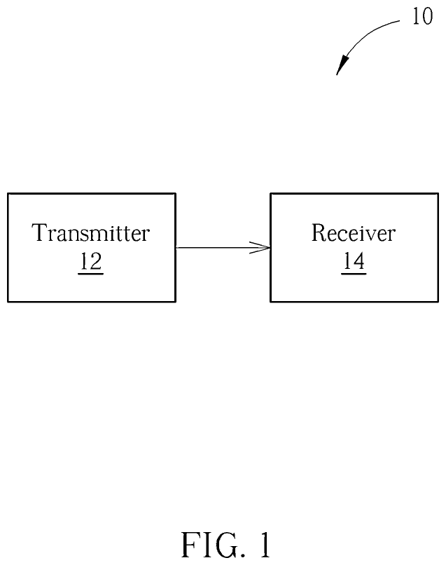

FIG. 1 is a schematic diagram of a communication system 10 according to an example of the present invention. The communication system 10 may be any communication system using an orthogonal frequency-division multiplexing (OFDM) technique (also termed a discrete multi-tone modulation (DMT) technique), and is composed of a transmitter 12 and a receiver 14. The communication system 10 may be any wired communication system such as an asymmetric digital subscriber line (ADSL) system, a power line communication (PLC) system or an Ethernet over coax (EOC), but is not limited herein.

The communication system 10 may alternatively be any wireless communication system such as a wireless local area network (WLAN), a Digital Video Broadcasting (DVB) system, a Long Term Evolution (LTE) system, a Long Term Evolution-advanced (LTE-A) system or a fifth generation (5G) system, but is not limited herein. In addition, the transmitter 12 and the receiver 14 may be installed in a mobile phone, a laptop, a personal computer, an access point (AP), etc., but is not limited herein.

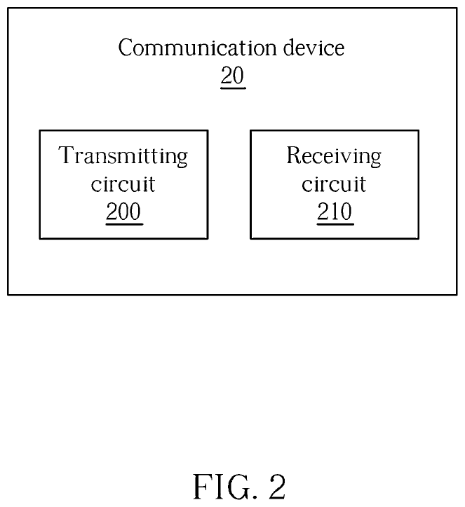

FIG. 2 is a schematic diagram of a communication device 20 according to an example of the present invention. The communication device 20 may be the transmitter 12 or the receiver 14 in FIG. 1, and may be used to reduce overhead caused by handshakes. The communication device 20 comprises a transmitting circuit 200 and a receiving circuit 210. In detail, the transmitting circuit 200 is configured to transmit a plurality of association request messages to a plurality of network devices (not shown), respectively. A network device may be the receiver 14 or the transmitter 12 in FIG. 1. Each of the plurality of association request messages comprises a same broadcast (BC) address and a same acknowledgement (ACK) policy. The plurality of association request messages comprise a plurality of first ACK priorities, respectively. The receiving circuit 210 is configured to receive a plurality of association response messages corresponding to the plurality of association request messages from the plurality of network devices, respectively (e.g., when the BC address is not registered by other communication devices). In addition, the transmitting circuit 200 transmits a first packet to the plurality of network devices according to the BC address. The receiving circuit 210 receives a plurality of ACKs corresponding to the first packet from the plurality of network devices, respectively, according to the plurality of first ACK priorities and the ACK policy.

In one example, the first packet comprises a first power bit, and the first power bit is used to notify the plurality of network devices that the communication device 20 enters or leaves a sleep mode. For example, the first power bit being “1” indicates that the communication device 20 enters the sleep mode. For example, the first power bit being “0” indicates that the communication device 20 leaves the sleep mode.

In one example, the plurality of first ACK priorities correspond to the plurality of network devices, respectively. In one example, the plurality of first ACK priorities indicate a plurality of time-domain resources for the receiving circuit 210 receiving the plurality of ACKs, respectively. In one example, the plurality of first ACK priorities indicate a plurality of time-domain resources for the plurality of network devices transmitting the plurality of ACKs, respectively. That is, the receiving circuit 210 receives the plurality of ACKs at different times (e.g., different time intervals), and/or the plurality of network devices transmits the plurality of ACKs at different times (e.g., different time intervals). In one example, the plurality of first ACK priorities indicate a plurality of frequency-domain resources for the receiving circuit 210 receiving the plurality of ACKs, respectively. In one example, the plurality of first ACK priorities indicate a plurality of frequency-domain resources for the plurality of network devices transmitting the plurality of ACKs, respectively. That is, the receiving circuit 210 receives the plurality of ACKs at different frequencies (e.g., different subcarriers or different resource units (RUs)), and/or the plurality of network devices transmit the plurality of ACKs at different frequencies (e.g., different subcarriers or different RUs).

In one example, the communication device 20 is configured with a BC basic service set identifier (BSSID). The communication device 20 and the plurality of network devices form a first service set according to the BSSID. In one example, the transmitting circuit 200 transmits BC data to the plurality of network devices according to the BSSID and the BC address. In one example, the BC data comprises a BC frame, and the BC frame comprises a frame control field, a duration field, a destination address (DA) field, a source address (SA) field, a BSSID field and a sequence control field. In one example, the ACK policy indicates a legacy or an orthogonal frequency division multiple access (OFDMA). The legacy represents that the plurality of network devices transmit the plurality of ACKs via a time division multiplexing (TDM). The OFDMA represents that the plurality of network devices transmit the plurality of ACKs via an RU allocation (RUA).

In one example, at least two association request messages of the plurality of association request messages comprise a same group address. The at least two association request messages comprise a plurality of second ACK priorities, respectively. In one example, the group address is associated with at least two network devices of the plurality of network devices. In one example, the at least two network devices are comprised in a same service set (or a same group). In one example, the plurality of second ACK priorities correspond to the at least two network devices, respectively, i.e., the plurality of second ACK priorities are associated with the at least two network devices.

In one example, the communication device 20 is configured with a group BSSID. The communication device 20 and the at least two network devices form a second service set according to the group BSSID. In one example, the transmitting circuit 200 transmits a second packet to the at least two network device according to the group BSSID and the group address. The receiving circuit 210 receives at least two ACKs corresponding to the second packet from the at least two network devices, respectively, according to the plurality of second ACK priorities and the ACK policy. In one example, the second packet comprises a second power bit, and the second power bit is used to notify the at least two network devices that the communication device 20 enters or leaves a sleep mode. For example, the second power bit being “1” indicates that the communication device 20 enters the sleep mode. For example, the second power bit being “0” indicates that the communication device 20 leaves the sleep mode.

In one example, the plurality of second ACK priorities indicate at least two time-domain resources for the receiving circuit 210 receiving the at least two ACKs, respectively. In one example, the plurality of second ACK priorities indicate at least two time-domain resources for the at least two network devices transmitting the at least two ACKs, respectively. That is, the receiving circuit 210 receives the at least two ACKs at different times (e.g., different time intervals), and/or the at least two network devices transmit the at least two ACKs at different times (e.g., different time intervals). In one example, the plurality of second ACK priorities indicate at least two frequency-domain resources for the receiving circuit 210 receiving the at least two ACKs, respectively. In one example, the plurality of second ACK priorities indicate at least two frequency-domain resources for the at least two network devices transmitting the at least two ACKs, respectively. That is, the receiving circuit 210 receives the at least two ACKs at different frequencies (e.g., different subcarriers or different RUs), and/or the at least two network devices transmit the at least two ACKs at different frequencies (e.g., different subcarriers or different RUs).

In one example, the transmitting circuit 200 transmits group data to the at least two network devices according to the group address. In one example, the group data comprises a group frame, and the group frame comprises a frame control field, a duration field, a DA field, a SA field, a BSSID field and a sequence control field.

In one example, the plurality of association request messages comprises a plurality of unicast (UC) addresses, respectively. In one example, the plurality of UC addresses correspond to the plurality of network devices, respectively. In one example, the transmitting circuit 200 transmits a third packet to at least one network device of the plurality of network devices according to at least one UC address of the plurality of UC addresses. The receiving circuit 210 receives at least one ACK corresponding to the third packet from the at least one network device, respectively. In one example, the third packet comprises a third power bit, and the third power bit is used to notify the at least one network devices that the communication device 20 enters or leaves a sleep mode. For example, the third power bit being “1” indicates that the communication device 20 enters the sleep mode. For example, the third power bit being “0” indicates that the communication device 20 leaves the sleep mode.

In one example, the transmitting circuit 200 transmits UC data to the at least one network device according to the at least one UC address. In one example, the UC data comprises a UC frame, and the UC frame comprises a frame control field, a duration field, a DA field, a SA field, a BSSID field and a sequence control field.

In one example, the plurality of UC addresses, the BC address and/or the group address is/are medium access control (MAC) address (es). In one example, the communication device 20 and the plurality of network devices operate in a wireless local area network (WLAN) such as WiFi and/or a personal area network (PAN) such as Bluetooth (BT), but are not limited herein. In one example, the communication device 20 and the plurality of network devices operate on a same channel. In one example, the plurality of network devices comprise at least one of at least one AP and at least one group owner (GO). The GO may be a mobile phone, a laptop, a projector, etc., but is not limited herein. In one example, after receiving an association request message of the plurality of association request messages, a network device of the plurality of network devices configures an association identity (AID) of the communication device 20. The AID is an index for the network device identifying the communication device 20. Then, the network device generates a mapping of the AID to the BC address. In one example, the network device further generates a mapping of the AID to the BC address (corresponding to the network device). In one example, the network device further generates a mapping of the AID to a UC address (corresponding to the network device).

In one example, when all addresses (e.g., at least one of a UC address, a BC address and a group address) in an association request message of the plurality of association request messages are not registered by other communication devices, a network device of the plurality of network devices (i.e., a network device which receives the association request message) transmits an association response message of the plurality of association response messages (i.e., an association response message corresponding to the association request message) to the receiving circuit 210. In one example, when at least one address (e.g., at least one of a UC address, a BC address and a group address) in an association request message of the plurality of association request messages is registered by other communication devices, a network device of the plurality of network devices (i.e., a network device which receives the association request message) transmits an association reject message corresponding to the association request message to the receiving circuit 210.

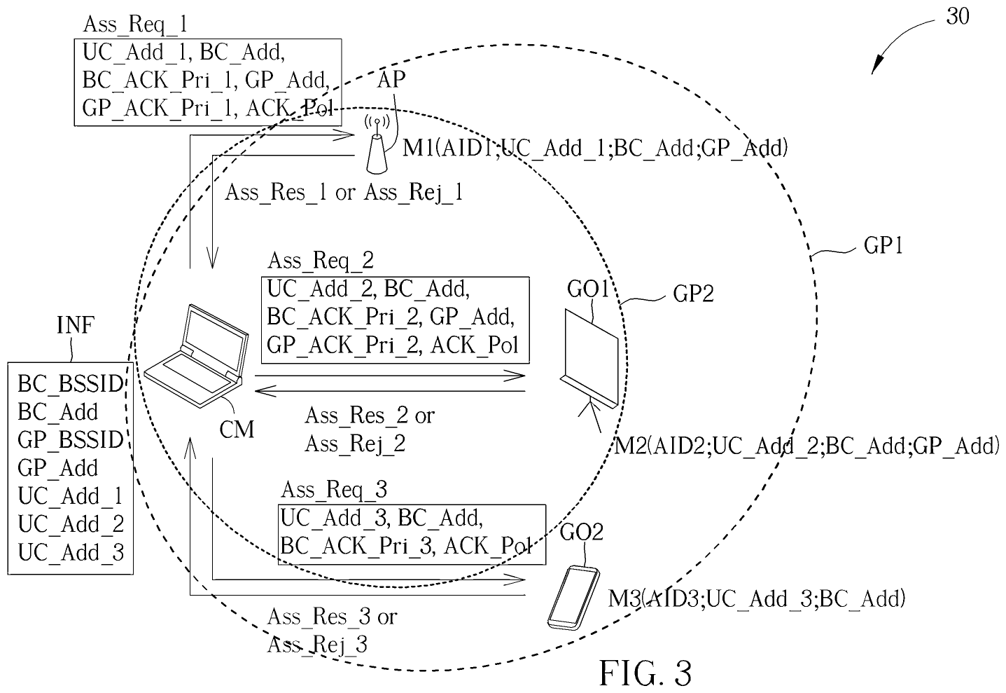

FIG. 3 is a schematic diagram of a scenario 30 according to an example of the present invention. FIG. 3 comprises a communication device CM, an access point AP and GOs GO1-GO2. The communication device CM can be the communication device 20, the access point AP and the GOs GO1-GO2 can be the plurality of network devices mentioned above, but are not limited herein. The communication device CM is configured with information INF. The information INF comprises a BC BSSID BC_BSSID, a BC address BC_Add, a group BSSID GP_BSSID, a group address GP_Add, a UC address UC_Add_1 of the access point AP, a UC address UC_Add_2 of the GO GO1 and a UC address UC_Add_3 of the GO GO2. The communication device CM, the access point AP and the GOs GO1-Go2 form a service set GP1 according to the BC BSSID BC_BSSID. The communication device CM, the access point AP and the GO GO1 form a service set GP2 according to the group BSSID GP_BSSID.

The communication device CM transmits an association request message Ass_Req_1 to the access point AP. The association request message Ass_Req_1 comprises the UC address UC_Add_1 of the access point AP, a BC address BC_Add, an ACK priority for BC BC_ACK_Pri_1 (e.g., a first ACK priority of the plurality of first ACK priorities), the group address GP_Add, an ACK priority for group GP_ACK_Pri_1 (e.g., a second ACK priority of the plurality of second ACK priorities) and an ACK policy ACK_Pol. The communication device transmits an association request message Ass_Req_2 to the GO GO1. The association request message Ass_Req_2 comprises the UC address UC_Add_2 of the GO GO1, the BC address BC_Add, an ACK priority for BC BC_ACK_Pri_2 (e.g., a first ACK priority of the plurality of first ACK priorities), the group address GP_Add, an ACK priority for group GP_ACK_Pri_2 (e.g., a second ACK priority of the plurality of second ACK priorities) and the ACK policy ACK_Pol. The communication device CM transmits an association request message Ass_Req_3 to the GO GO2. The association request message Ass_Req_3 comprises the UC address UC_Add_3 of the GO GO2, the BC address BC_Add, an ACK priority for BC BC_ACK_Pri_3 (e.g., a first ACK priority of the plurality of first ACK priorities) and the ACK policy ACK_Pol.

When the UC address UC_Add_1, the BC address BC_Add and the group address GP_Add are not registered by other communication device, the access point AP transmits an association response message Ass_Res_1 to the communication device CM to notify the communication device CM that the registration is successful. The access point AP configures an AID AID1 for the communication device CM, and generates a mapping M1 of the AID AID1 to the UC address UC_Add_1, the BC address BC_Add and the group address GP_Add. When the UC address UC_Add_2, the BC address BC_Add and the group address GP_Add are not registered by other communication devices, the GO GO1 transmits an association response message Ass_Res_2 to the communication device CM to notify the communication device CM that the registration is successful. The GO GO1 configures an AID AID2 for the communication device CM, and generates a mapping M2 of the AID AID2 to the UC address UC_Add_2, the BC address BC_Add and the group address GP_Add. When the UC address UC_Add_3 and the BC address BC_Add are not registered by other communication devices, the GO GO2 transmits an association response message Ass_Res_3 to the communication device CM to notify the communication device CM that the registration is successful. The GO GO2 configures an AID AID3 for the communication device CM, and generates a mapping M3 of the AID AID3 to the UC address UC_Add_3 and the BC address BC_Add.

When at least one of the UC address UC_Add_1, the BC address BC_Add and the group address GP_Add is registered by other communication devices, the access point AP transmits an association rejection message Ass_Rej_1 to the communication device CM to notify the communication device CM that the registration fails. When at least one of the UC address UC_Add_2, the BC address BC_Add and the group address GP_Add is registered by other communication devices, the GO GO1 transmits an association rejection message Ass_Rej_2 to the communication device CM to notify the communication device CM that the registration fails. When at least one of the UC address UC_Add_3 and the BC address BC_Add are not registered by other communication devices, the GO GO2 transmits an association rejection message Ass_Rej_3 to the communication device CM to notify the communication device CM that the registration fails. Then, the communication device CM reselects address(es) in response to the association rejection message(s) Ass_Rej_1, Ass_Rej_2 and/or Ass_Rej_3. The reselected address(es) replaces the address(es) registered by other communication device. The communication device CM retransmits the association request message(s) Ass_Req_1, Ass_Req_2 and/or Ass_Req_3 comprising the reselected address (es).

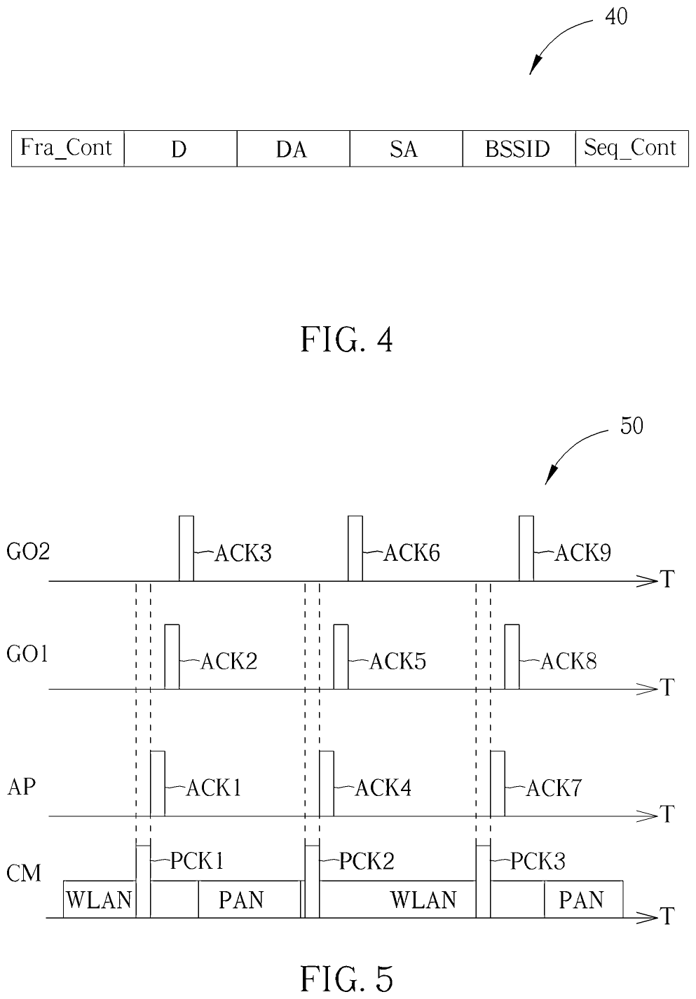

FIG. 4 is a schematic diagram of a frame 40 according to an example of the present invention. FIG. 4 may be applied to the example shown in FIG. 3, but is not limited herein. A communication device (not shown in FIG. 4) (e.g., the communication device 20 in FIG. 2 or the communication device CM in FIG. 3) transmits the frame 40 to a network device (not shown in FIG. 4) (e.g., any one of the plurality of network devices mentioned above or any one of the access point AP and the GOs GO1-GO2 in FIG. 3). The frame 40 comprises a frame control field Fra_Cont, a duration field D, a DA field DA, an SA field SA, a BSSID field BSSID and a sequence control field Seq_Cont. The frame control field Fra_Cont indicates a characteristic of a packet comprising the frame 40 such as a type of the packet, whether the packet comprises a power bit and/or whether the packet is a retransmitted packet, etc. The duration field D indicates an expected packet transmission time. The sequence control field Seq_Cont comprises a sequence number and a fragment number. The sequence number indicates an order in which the packet is transmitted. The fragment number indicates a position of the packet in data.

In one example, in the case that the frame 40 is a UC frame, the DA field DA indicates an address of the network device, the SA field SA indicates a UC address corresponding to the network device (e.g., the UC address UC_Add_1, UC_Add_2 or UC_Add_3 in FIG. 3), and the BSSID field BSSID indicates a BSSID of the network device. In one example, in the case that the frame 40 is a BC frame, the DA field DA indicates an address for BC, the SA field SA indicates a BC address (e.g., the BC address BC_Add in FIG. 3), and the BSSID field BSSID indicates a BC BSSID of the communication device (e.g., the BC BSSID BC_BSSID in FIG. 3). In one example, in the case that the frame 40 is a group frame, the DA field DA indicates an address for group, the SA field SA indicates a group address (e.g., the group address GP_Add in FIG. 3), and the BSSID field BSSID indicates a group BSSID of the communication device (e.g., the group BSSID GP_BSSID in FIG. 3).

FIG. 5 is a schematic diagram of a handshake mechanism 50 according to an example of the present invention. FIG. 5 may be applied to the example shown in FIG. 3, but is not limited herein. FIG. 5 comprises a communication device CM, an access point AP and GOs GO1-GO2. For convenience of description, the communication device CM, the access point AP and the GOs GO1-GO2 individually correspond to a time dimension T. Through a TDM, the communication device CM operates alternately in the wireless local area network WLAN and the personal area network PAN. It is assumed that the ACK policy is a legacy, and an order for transmitting ACKs (e.g., obtained according to ACK priorities for BC) is the access point AP, the GO GO1 and the GO GO2.

The communication device CM transmits a packet PCK1 with a power bit being “1” to the access point AP and the GOs GO1-GO2 according to a BC address (e.g., the BC address BC_Add in FIG. 3), in order to notify the access point AP and the GOs GO1-GO2 that the communication device CM enters a sleeping mode. The access point AP and the GOs GO1-GO2 transmit ACKs ACK1-ACK3 to the communication device CM at different times, respectively, according to the ACK policy (i.e., the legacy) and the ACK priorities for BC, in response to the packet PK1. For example, the access point AP transmits the ACK ACK1 in a first slot of a certain symbol, the GO GO1 transmits the ACK ACK2 in a second slot of the certain symbol, and the GO GO2 transmits the ACK ACK3 in a third slot of the certain symbol.

The communication device CM transmits a packet PCK2 with a power bit being “0” to the access point AP and the GOs gO1-GO2 according to the BC address (e.g., the BC address BC_Add in FIG. 3), in order to notify the access point AP and the GOs gO1-GO2 that the communication device CM leaves the sleeping mode. The access point AP and the GOs gO1-GO2 transmit ACKs ACK4-ACK6, respectively, at different times according to the ACK policy (i.e., the legacy) and the ACK priorities for BC, in response to the packet PK2. For example, the access point AP transmits the ACK ACK4 in a first slot of a certain symbol, the GO GO1 transmits the ACK ACK5 in a second slot of the certain symbol, and the GO GO2 transmits the ACK ACK6 in a third slot of the certain symbol.

Details of a packet PCK3 and ACKs ACK7-ACK9 can be known by referring to the descriptions of the packet PCK1 and the ACKs ACK1˜ACK3, and are not narrated herein.

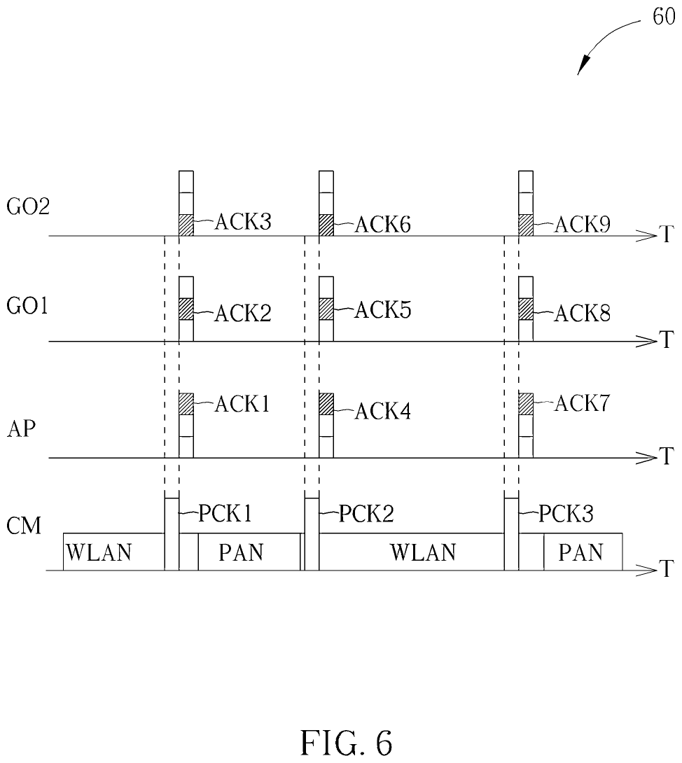

FIG. 6 is a schematic diagram of a handshake mechanism 60 according to an example of the present invention. FIG. 6 may be applied to the example shown in FIG. 3, but is not limited herein.

FIG. 6 comprises a communication device CM, an access point AP and GOs GO1-GO2. For convenience of description, the communication device CM, the access point AP and the GOs GO1-GO2 individually correspond to a time dimension T. Through a TDM, the communication device CM operates alternately in the wireless local area network WLAN and the personal area network PAN. It is assumed that the ACK policy is an OFDMA, and an order for transmitting ACKs (e.g., obtained according to ACK priorities for BC) is the access point AP, the GO GO1 and the GO GO2.

The communication device CM transmits a packet PCK1 with a power bit being “1” to the access point AP and the GOs GO1-GO2 according to a BC address (e.g., the BC address BC_Add in FIG. 3), in order to notify the access point AP and the GOs GO1-GO2 that the communication device CM enters a sleeping mode. The access point AP and the GOs GO1-GO2 transmit ACKs ACK1-ACK3 to the communication device CM at different frequencies (shown by slashes), respectively, according to the ACK policy (i.e., the OFDMA) and the ACK priorities for BC, in response to the packet PK1. For example, the access point AP transmits the ACK ACK1 at a first subcarrier of a certain carrier, the GO GO1 transmits the ACK ACK2 at a second subcarrier of the certain carrier, and the GO GO2 transmits the ACK ACK3 at a third subcarrier of the certain carrier.

The communication device CM transmits a packet PCK2 with a power bit being “0” to the access point AP and the GOs GO1-GO2 according to the BC address (e.g., the BC address BC_Add in FIG. 3), in order to notify the access point AP and the GOs GO1-GO2 that the communication device CM leaves the sleeping mode. The access point AP and the GOs gO1-GO2 transmit ACKs ACK4-ACK6 to the communication device CM at different frequencies (shown by slashes), respectively, according to the ACK policy (i.e., the OFDMA) and the ACK priorities for BC, in response to the packet PK2. For example, the access point AP transmits the ACK ACK4 at a first subcarrier of a certain carrier, the GO GO1 transmits the ACK ACK5 at a second subcarrier of the certain carrier, and the GO GO2 transmits the ACK ACK6 at a third subcarrier of the certain carrier.

Details of a packet PCK3 and ACKs ACK7-ACK9 can be known by referring to the descriptions of the packet PCK1 and the ACKs ACK1˜ACK3, and are not narrated herein.

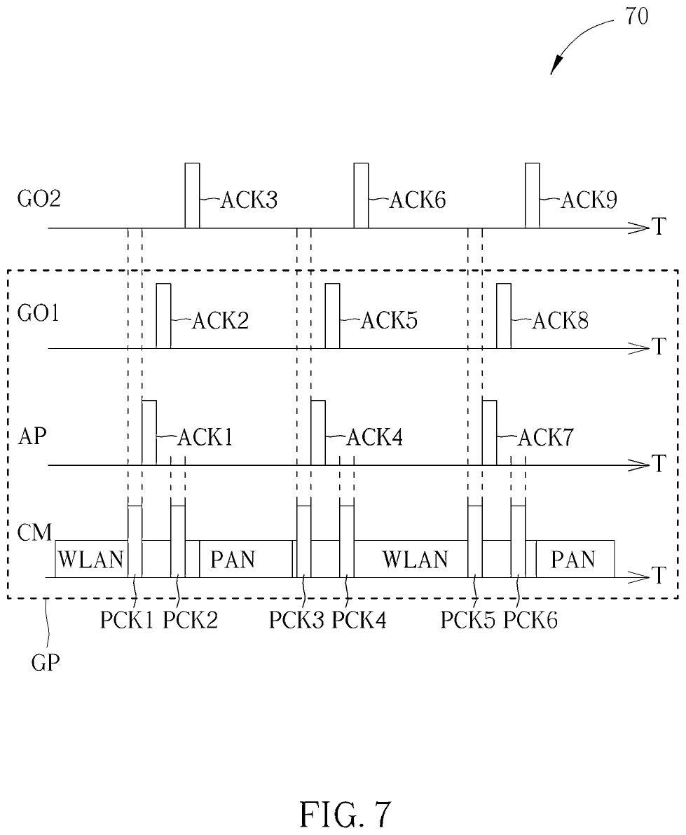

FIG. 7 is a schematic diagram of a handshake mechanism 70 according to an example of the present invention. FIG. 7 may be applied to the example shown in FIG. 3, but is not limited herein.

FIG. 7 comprises a communication device CM, an access point AP and GOs GO1-GO2, wherein the communication device CM, the access point AP and the GO GO1 are comprised in a service set GP. For convenience of description, the communication device CM, the access point AP and the GOs GO1-GO2 individually correspond to a time dimension T. Through a TDM, the communication device CM operates alternately in the wireless local area network WLAN and the personal area network PAN. It is assumed that the ACK policy is a legacy, and an order for transmitting ACKs (e.g., obtained according to ACK priorities for group) is the access point AP and the GO GO1.

The communication device CM transmits a packet PCK1 with a power bit being “1” to the access point AP and the GO GO1 according to a group address (e.g., the group address GP_Add in FIG. 3), in order to notify the access point AP and the GO GO1 that the communication device CM enters a sleeping mode. The access point AP and the GO GO1 transmit ACKs ACK1-ACK2 to the communication device CM at different times, respectively, according to the ACK policy (i.e., the legacy) and the ACK priorities for group, in response to the packet PK1. For example, the access point AP transmits the ACK ACK1 in a first slot of a certain symbol, and the GO GO1 transmits the ACK ACK2 in a second slot of the certain symbol. Then, the communication device CM transmits a packet PCK2 with a power bit being “1” to the GO GO2 according to a UC address of the GO GO2 (e.g., the UC address UC_Add_3 in FIG. 3), in order to notify the GO GO2 that the communication device CM enters the sleeping mode. The GO GO2 transmits an ACK ACK3 to the communication device CM, in response to the packet PCK2.

The communication device CM transmits a packet PCK3 with a power bit being “0” to the access point AP and the GO GO1 according to the group address (e.g., the group address GP_Add in FIG. 3), in order to notify the access point AP and the GO GO1 that the communication device CM leaves the sleeping mode. The access point AP and the GO GO1 transmit ACKs ACK4-ACK5 to the communication device CM at different times, respectively, according to the ACK policy (i.e., the legacy) and the ACK priorities for group, in response to the packet PK3. For example, the access point AP transmits the ACK ACK4 in a first slot of a certain symbol, and the GO GO1 transmits the ACK ACK5 in a second slot of the certain symbol. Then, the communication device CM transmits a packet PCK4 with a power bit being “0” to the GO GO2 according to the UC address of the GO GO2 (e.g., the UC address UC_Add_3 in FIG. 3), in order to notify the GO GO2 that the communication device CM leaves the sleeping mode. The GO GO2 transmits an ACK ACK6 to the communication device, in response to the packet PCK4.

Details of packets PCK5-PCK6 and ACKs ACK7-ACK9 can be known by referring to the descriptions of the packets PCK1-PCK2 and the ACKs ACK1˜ACK3, and are not narrated herein.

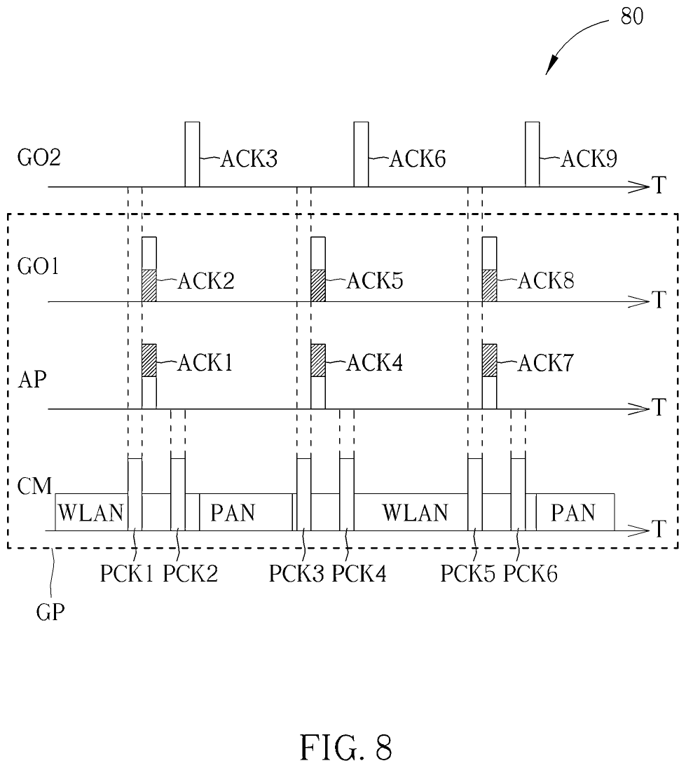

FIG. 8 is a schematic diagram of a handshake mechanism 80 according to an example of the present invention. FIG. 8 may be applied to the example shown in FIG. 3, but is not limited herein. FIG. 8 comprises a communication device CM, an access point AP and GOs GO1-GO2, wherein the communication device CM, the access point AP and the GO GO1 are comprised in a service set GP. For convenience of description, the communication device CM, the access point AP and the GOs GO1-GO2 individually correspond to a time dimension T. Through a TDM, the communication device CM operates alternately in the wireless local area network WLAN and the personal area network PAN. It is assumed that the ACK policy is an OFDMA, and an order for transmitting ACKs (e.g., obtained according to ACK priorities for group) is the access point AP and the GO GO1.

The communication device CM transmits a packet PCK1 with a power bit being “1” to the access point AP and the GO GO1 according to a group address (e.g., the group address GP_Add in FIG. 3), in order to notify the access point AP and the GO GO1 that the communication device CM enters a sleeping mode. The access point AP and the GO GO1 transmit ACKs ACK1-ACK2 to the communication device CM at different frequencies (shown by slashes), respectively, according to the ACK policy (i.e., the OFDMA) and the ACK priorities for group, in response to the packet PK1. For example, the access point AP transmits the ACK ACK1 at a first subcarrier of a certain carrier, and the GO GO1 transmits the ACK ACK2 at a second subcarrier of the certain carrier. Then, the communication device CM transmits a packet PCK2 with a power bit being “1” to the GO GO2 according to a UC address of the GO GO2 (e.g., the UC address UC_Add_3 in FIG. 3), in order to notify the GO GO2 that the communication device CM enters the sleeping mode. The GO GO2 transmits an ACK ACK3 to the communication device CM, in response to the packet PCK2.

The communication device CM transmits a packet PCK3 with a power bit being “0” to the access point AP and the GO GO1 according to the group address (e.g., the group address GP_Add in FIG. 3), in order to notify the access point AP and the GO GO1 that the communication device CM leaves the sleeping mode. The access point AP and the GO GO1 transmit ACKs ACK4-ACK5 to the communication device CM at different frequencies (shown by slashes), respectively, according to the ACK policy (i.e., the OFDMA) and the ACK priorities for group, in response to the packet PK3. For example, the access point AP transmits the ACK ACK4 at a first subcarrier of a certain carrier, and the GO GO1 transmits the ACK ACK5 at a second subcarrier of the certain carrier. Then, the communication device CM transmits a packet PCK4 with a power bit being “0” to the GO GO2 according to the UC address of the GO GO2 (e.g., the UC address UC_Add_3 in FIG. 3), in order to notify the GO GO2 that the communication device CM leaves the sleeping mode. The GO GO2 transmits an ACK ACK3 to the communication device CM, in response to the packet PCK4.

Details of packets PCK5-PCK6 and ACKs ACK7-ACK9 can be known by referring to the descriptions of the packets PCK1-PCK2 and the ACKs ACK1˜ACK3, and are not narrated herein.

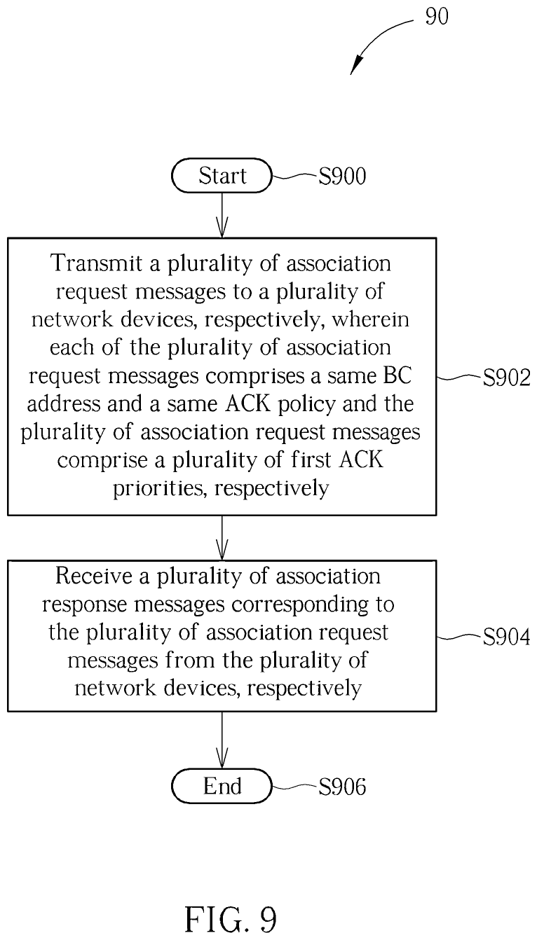

Operations of the communication device 20 in the above examples can be summarized into a process 90 shown in FIG. 9, which reduces a handover caused by handshakes. The process 90 includes the following steps:
Step S900: Start.
Step S902: Transmit a plurality of association request messages to a plurality of network devices, respectively, wherein each of the plurality of association request messages comprises a same BC address and a same ACK policy and the plurality of association request messages comprise a plurality of first ACK priorities, respectively.
Step S904: Receive a plurality of association response messages corresponding to the plurality of association request messages from the plurality of network devices, respectively.
Step S906: End.

Detailed descriptions and variations of the process 90 can be known by referring to the previous description, and are not narrated herein.

The terms “first” and “second” are used to distinguish related statements, but are not used to limit an order of related statements. The term “according to” described above may be replaced by the term “via”, “by using” or “in response to”. The term “comprise” described above may be replaced by the term “is”.

It should be noted that there are various possible realizations of the communication device 20 (including the transmitting circuit 200 and the receiving circuit 210). For example, the circuits mentioned above may be integrated into one or more circuits. In addition, the communication device 20 and the circuits in the communication device 20 may be realized by hardware (e.g., circuits), software, firmware (known as a combination of a hardware device, computer instructions and data that reside as read-only software on the hardware device), an electronic system or a combination of the devices mentioned above, but are not limited herein.

To sum up, the present invention provides a communication device and a communication method. Association request messages transmitted by the communication device to network devices comprise BC/group address, ACK priorities for BC/group and an ACK policy. The communication device communicates with the network devices by using information in the association request messages, to reduce the number of packets transmitted by the communication device when performing handshakes. Compared with the prior art (e.g., by using multiple UC addresses, the communication device communicates with the network devices independently), the invention reduces the handover caused by handshakes and improves a channel utilization.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device, comprising:
a transmitting circuit, for transmitting a plurality of association request messages to a plurality of network devices, respectively, wherein each of the plurality of association request messages comprises a same broadcast (BC) address and a same acknowledgement (ACK) policy and the plurality of association request messages comprise a plurality of first ACK priorities, respectively; and
a receiving circuit, for receiving a plurality of association response messages corresponding to the plurality of association request messages from the plurality of network devices, respectively.

2. The communication device of claim 1, wherein the transmitting circuit transmits a packet to the plurality of network devices according to the BC address; and the receiving circuit receives a plurality of ACKs corresponding to the packet from the plurality of network devices, respectively, according to the plurality of first ACK priorities and the ACK policy.

3. The communication device of claim 2, wherein the plurality of first ACK priorities indicate a plurality of time-domain resources for the receiving circuit receiving the plurality of ACKs, respectively.

4. The communication device of claim 2, wherein the plurality of first ACK priorities indicate a plurality of frequency-domain resources for the receiving circuit receiving the plurality of ACKs, respectively.

5. The communication device of claim 1, wherein the ACK policy indicates a legacy or an orthogonal frequency division multiple access (OFDMA).

6. The communication device of claim 1, wherein at least two association request messages of the plurality of association request messages comprise a same group address, and the at least two association request messages comprise a plurality of second ACK priorities, respectively, wherein the group address and the plurality of second ACK priorities are associated with at least two network devices of the plurality of network devices.

7. The communication device of claim 6, wherein the transmitting circuit transmits a packet to the at least two network devices according to the group address, and the receiving circuit receives at least two ACKs corresponding to the packet from the at least two network devices, respectively, according to the plurality of second ACK priorities and the ACK policy.

8. The communication device of claim 7, wherein the plurality of second ACK priorities indicate at least two time-domain resources for the receiving circuit receiving the at least two ACKs, respectively.

9. The communication device of claim 7, wherein the plurality of second ACK priorities indicate at least two frequency-domain resources for the receiving circuit receiving the at least two ACKs, respectively.

10. A communication method, comprising:
transmitting a plurality of association request messages to a plurality of network devices, respectively, wherein each of the plurality of association request messages comprises a same broadcast (BC) address and a same acknowledgement (ACK) policy and the plurality of association request messages comprise a plurality of first ACK priorities, respectively; and
receiving a plurality of association response messages corresponding to the plurality of association request messages from the plurality of network devices, respectively.

11. The communication method of claim 10, wherein the transmitting circuit transmits a packet to the plurality of network devices according to the BC address; and the receiving circuit receives a plurality of ACKs corresponding to the packet from the plurality of network devices, respectively, according to the plurality of first ACK priorities and the ACK policy.

12. The communication method of claim 11, wherein the plurality of first ACK priorities indicate a plurality of time-domain resources for the receiving circuit receiving the plurality of ACKs, respectively.

13. The communication method of claim 11, wherein the plurality of first ACK priorities indicate a plurality of frequency-domain resources for the receiving circuit receiving the plurality of ACKs, respectively.

14. The communication method of claim 10, wherein the ACK policy indicates a legacy or an orthogonal frequency division multiple access (OFDMA).

15. The communication method of claim 10, wherein at least two association request messages of the plurality of association request messages comprise a same group address, and the at least two association request messages comprise a plurality of second ACK priorities, respectively, wherein the group address and the plurality of second ACK priorities are associated with at least two network devices of the plurality of network devices.

16. The communication method of claim 15, wherein the transmitting circuit transmits a packet to the at least two network devices according to the group address, and the receiving circuit receives at least two ACKs corresponding to the packet from the at least two network devices, respectively, according to the plurality of second ACK priorities and the ACK policy.

17. The communication method of claim 16, wherein the plurality of second ACK priorities indicate at least two time-domain resources for the receiving circuit receiving the at least two ACKs, respectively.

18. The communication method of claim 16, wherein the plurality of second ACK priorities indicate at least two frequency-domain resources for the receiving circuit receiving the at least two ACKs, respectively.
